(19) United States
(12) Patent Application Publication
(10) Pub. No.: US 2022/0013895 A1
(43) Pub. Date: Jan. 13, 2022

(54) ANTENNA DEVICE

(71) Applicant: Mitsubishi Electric Corporation, Tokyo (JP)

(72) Inventor: Akihiro NAGASE, Chiyoda ku, Tokyo (JP)

(73) Assignee: Mitsubishi Electric Corporation, Tokyo (JP)

(21) Appl. No.: 17/291,280

(22) PCT Filed: Dec. 28, 2018
(86) PCT No.: PCT/JP2018/048436

§ 371 Date: May 5, 2021

(51) Int. Cl. H01Q 1/42; H01Q 1/02; H01Q 21/06

(52) U.S. Cl. CPC H01Q 1/42; H01Q 21/061; H01Q 1/02

(57) ABSTRACT

The array antenna are disposed on a planar antenna adapter. The antenna adapter is disposed to face an outer surface of a mobile object with a gap interposed therebetween, and is provided with a plurality of through holes, each of which penetrates a first surface on which the array antenna is disposed and a second surface facing the outer surface of the mobile object. The array antenna and the antenna adapter are covered by a radome. A skirt is fixed to the outer peripheral edge of the antenna adapter, and the skirt is joined to the radome and the outer surface of the mobile object. A blower is disposed in a space hermetically enclosed by the radome, the skirt and the outer surface of the mobile object to generate an airflow that flows in a space surrounded by the radome and the first surface.

### TECHNICAL FIELD

The present invention relates to a phased array antenna device mounted on a mobile object.

### BACKGROUND ART

In recent years, Internet services using satellite lines and the like have become available in mobile objects such as aircrafts and railway trains. In order to comfortably view contents such as videos and pictures in a mobile object, an antenna device is required to have a fast communication speed and a large communication capacity.

On the other hand, in order to reduce fuel consumption of a mobile object that moves at a high speed such as an aircraft, it is important to reduce air resistance. In order to reduce the air resistance, it is required to reduce the cross-sectional area (hereinafter, referred to as the projection area) of the mobile object when viewed from the front in the traveling direction, or to enable the mobile object a streamline shape so as to reduce wake separation, which limits the space for installing the antenna device in the mobile object. In a conventional mechanically driven antenna device, in order to accommodate a mechanical unit which is configured to mechanically drive an aperture or a reflecting plate of the antenna so as to control the directivity, the antenna device is required to have a height of several dozen centimeters. Therefore, when a mechanically driven antenna device is mounted on the mobile object, there is a limit in reducing the air resistance.

Therefore, a phased array type antenna device has been developed as a means to make the antenna device thinner in thickness. The phased array type antenna device includes an array antenna in which a plurality of antenna elements are regularly arranged, and the directivity of the array antenna may be electronically controlled by individually phase-controlling signals transmitted and received by each antenna element, which makes it possible to reduce the thickness of the entire antenna device.

On the other hand, in the phased array type antenna device, in order to increase the communication speed and the communication capacity, it is required to increase the frequency of signals and increase the integration degree of antenna elements, which makes the heat generation density higher than that of a conventional mechanically driven antenna device. Further, the antenna element is made of semiconductor, and in order to obtain desired performance, it is required to sufficiently cool the antenna element so as to maintain the junction temperature at about 100° C. or lower.

Therefore, in the phased array type antenna device, a method of radiating heat by air current obtained by the movement of the mobile object has been developed. For example, PTL 1 discloses a phased array type antenna device that includes: a printed circuit board; a plurality of antenna elements; a plurality of antenna element operation modules; and an exterior plate made of a good thermal conductor and formed with a plurality of antenna element accommodation holes for accommodating a plurality of antenna elements disposed in a predetermined arrangement on one surface of the printed circuit board, wherein the exterior plate is attached to a surface of a mobile object with a surface thereof exposed to an external space, and heat generated by the antenna element operation modules is transferred to the printed circuit board and the exterior plate, and is radiated from the exterior plate by the air current flowing along the surface of the exterior plate as the mobile object moves.

### CITATION LIST

### Patent Literature

PTL 1: Japanese Patent Laying-Open No. 2008-167020

### SUMMARY OF INVENTION

### Technical Problem

However, if the radome of the exterior plate exposed to the external space and the array antenna are brought into close contact with each other, the array antenna may be damaged by a lightning strike or the like. On the other hand, if the radome and the array antenna are separated from each other, it is difficult to ensure a heat radiation path and a heat radiation area while maintaining the antenna device thinner in thickness.

The present invention has been made in order to solve the aforementioned problems, and an object of the present invention is to provide an antenna device that is thinner in thickness and superior in heat radiation efficiency.

### Solution to Problem

The antenna device according to the present invention includes: an array antenna that transmits a radio wave to a communication target or receives a radio wave from the communication target; an antenna adapter that has a surface on which the array antenna is disposed and a surface facing an outer surface of a mobile object with a gap interposed therebetween, and is provided with a plurality of through holes penetrating the surface on which the array antenna is disposed and the surface facing the outer surface of the mobile object; a radome that is provided to cover the surface of the antenna adapter on which the array antenna is disposed with a gap interposed therebetween; a skirt that is provided on an outer peripheral edge of the antenna adapter, one end of which is joined to the radome and the other end thereof is joined to the outer surface of the mobile object in close contact; and a blower that is disposed inside a space hermetically enclosed by the radome, the skirt and the outer surface of the mobile object so as to generate an airflow flowing in a space surrounded by the radome and the surface of the antenna adapter on which the array antenna is disposed.

### Advantageous Effects of Invention

According to the antenna device of the present invention, the blower is disposed in a space hermetically enclosed by the radome, the skirt and the outer surface of the mobile object and configured to generate an airflow that flows in a space surrounded by the radome and the surface of the antenna adapter on which the array antenna is disposed so as to cool the array antenna, whereby it is possible to provide an antenna device that is thinner in thickness and superior in heat radiation efficiency.

### BRIEF DESCRIPTION OF DRAWINGS

FIG. 1 is a perspective view illustrating a schematic structure of an antenna device according to a first embodiment of the present invention;

FIG. 2 is a cross-sectional view illustrating a schematic structure of the antenna device according to the first embodiment of the present invention;

FIG. 3 is a cross-sectional view illustrating a schematic structure of the antenna device according to the first embodiment of the present invention;

FIG. 4 is an enlarged view illustrating a part of the schematic structure of the antenna device according to the first embodiment of the present invention;

FIG. 5 is an enlarged view illustrating a part of the schematic structure of the antenna device according to the first embodiment of the present invention;

FIG. 6 is a cross-sectional view illustrating a schematic structure of a comparative example of the antenna device according to the first embodiment of the present invention;

FIG. 7 is a perspective view illustrating a schematic structure of an antenna device according to a second embodiment of the present invention;

FIG. 8 is a cross-sectional view illustrating a schematic structure of the antenna device according to the second embodiment of the present invention;

FIG. 9 is a cross-sectional view illustrating a schematic structure of the antenna device according to the second embodiment of the present invention;

FIG. 10 is a cross-sectional view illustrating a schematic structure of a modification of the antenna device according to the second embodiment of the present invention;

FIG. 11 is a perspective view illustrating a schematic structure of an antenna device according to a third embodiment of the present invention; and

FIG. 12 is a cross-sectional view illustrating a schematic structure of the antenna device according to the third embodiment of the present invention.

### DESCRIPTION OF EMBODIMENTS

### First Embodiment

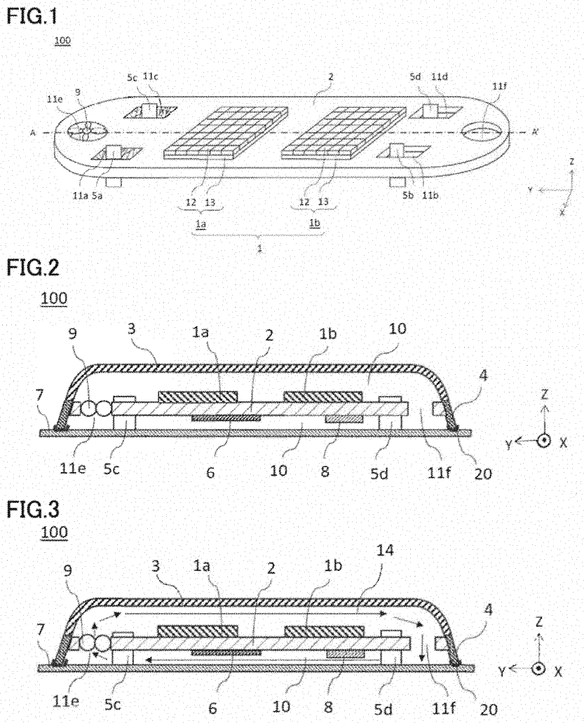

FIG. 1 is a perspective view illustrating a schematic structure of an antenna device according to a first embodiment of the present invention, and FIG. 2 is a cross-sectional view illustrating a schematic structure of the antenna device according to the first embodiment of the present invention. In the present embodiment, an antenna device 100 is mounted on a mobile object such as an aircraft for communication via an artificial satellite, and is attached to an outer surface 7 of a mobile object. In the drawings, the direction orthogonal to the outer surface 7 of the mobile object is denoted as the Z-axis, the traveling direction of a mobile object is denoted as the Y-axis, and the width direction of the antenna device 100 orthogonal to the traveling direction is denoted as the X-axis. In the following description, the positive direction of the Z-axis is referred to as the up direction, and the negative direction of the Z-axis is referred to as the down direction; the positive direction of the Y-axis is referred to as the front direction, and the negative direction of the Y-axis is referred to as the rear direction. Further, the traveling direction of the mobile object is assumed to be the same as the direction along which a front part and a rear part of the mobile object are connected by a straight line. If the mobile object is, for example, an aircraft, the traveling direction is identical to the direction from the nose toward the tail of the aircraft.

As illustrated in FIGS. 1 and 2, the antenna device 100 includes an array antenna 1, an antenna adapter 2, a radome 3, a skirt 4, a power supply 6, a control circuit 8, and a blower 9. FIG. 2 is a cross-sectional view taken along line AA′ of FIG. 1, and in FIG. 1, in order to show components inside the antenna device 100, a part of the antenna device 100 such as the radome 3 or the like is omitted.

The array antenna 1 is a planar communication module including a transmitting array antenna 1a that transmits a radio wave to a communication target and a receiving array antenna 1b that receives a radio wave from the communication target. The transmitting array antenna 1a and the receiving array antenna 1b are disposed in a central portion of the antenna adapter 2 with a distance therebetween. In the present embodiment, the communication target is, for example, an artificial satellite.

Each of the transmitting array antenna 1a and the receiving array antenna 1b includes a plurality of antenna elements 12 arranged in a grid pattern, and a communication IC 13 that causes the antenna elements 12 to perform a predetermined operation. The array antenna 1 is an active electronic scanning array antenna, and is configured to adjust the directivity of the radio wave by controlling an amount of phase shift of each antenna element 12 so as to track the communication target such as an artificial satellite. The array antenna 1 generates heat when transmitting or receiving the radio wave.

The antenna adapter 2 is, for example, a flat substrate, and is disposed to face the outer surface 7 of the mobile object with a predetermined gap interposed therebetween. The antenna adapter 2 has a surface on which the array antenna 1 is disposed and a surface facing the outer surface 7 of the mobile object. The power supply 6 configured to supply power to the array antenna 1 and the control circuit 8 configured to transmit a control signal to the array antenna 1 are disposed on the surface facing the outer surface 7 of the mobile object.

When the mobile object is moving at a high speed, a lift force will be generated in the antenna device 100 by the air resistance. Thus, the antenna adapter 2 is fixed and supported by, for example, a plurality of mounting brackets 5a to 5d disposed on the outer surface 7 of the mobile object so as to disperse the force applied to each mounting bracket by the lift force. The antenna adapter 2 also functions to provide rigidity to the entire antenna device 100 so as to prevent it from being deformed by the lift force. The antenna adapter 2 is formed by cutting it out from a metal material having a high thermal conductivity such as aluminum. The antenna adapter 2 serves as a heat radiation path to radiate heat generated by the array antenna 1, the power supply 6, the control circuit 8 and the like.

The antenna adapter 2 is provided with a plurality of through holes 11a to 11f, each of which penetrates the surface on which the array antenna 1 is disposed and the surface facing the outer surface 7 of the mobile object. The plurality of through holes 11a to 11f have different sizes depending on different roles. The through holes 11a to 11d near the outer peripheral edge of the antenna adapter 2 are provided with receiving brackets (not shown) to mate with the mounting brackets 5a to 5d, respectively. An electric wire that connects the array antenna 1, the control circuit 8 and the power supply 6 to each other are routed to pass through the through holes 11a and 11c to both surfaces of the antenna adapter 2. The blower 9 is disposed inside the through hole 11e, which will be described later. The through holes 11a to 11f may be provided for the purpose to reduce the weight of the antenna adapter 2. Hereinafter, the mounting brackets 5a to 5d may be collectively referred to as the mounting bracket 5, and the through holes 11a to 11f may be collectively referred to as the through hole 11 where appropriate.

The radome 3 covers the surface of the antenna adapter 2 on which the array antenna 1 is disposed with a gap interposed therebetween, and functions to protect the array antenna 1 from disturbances such as wind, rain or dust. Since the radio wave is required to pass through the radome 3, the radome 3 is made of a material such as resin which has a low dielectric constant so as to allow the radio wave to pass through easily. The radome 3 is continuously joined to the skirt 4 and formed into a substantially streamline shape as a whole. Therefore, when the mobile object moves at a high speed, the air resistance to be generated is minimal.

The skirt 4 is formed as a substantially elliptical truncated cone hollow inside, and is provided on the outer peripheral edge of the antenna adapter 2. One end of the skirt 4 is joined to the radome 3, and the other end of the skirt 4 is joined in close contact to the outer surface 7 of the mobile object via an elastic member 20 such as a rubber washer. Since the skirt 4 is provided in close contact with the outer surface 7 of the mobile object, even if the mobile object expands due to a preload or the like and thereby the outer surface 7 of the mobile object is bent, the outside air is prevented from flowing into the gap between the antenna adapter 2 and the outer surface 7 of the mobile object. Since the outside air cannot flow into the gap between the antenna adapter 2 and the outer surface 7 of the mobile object, it is possible to significantly reduce the risk of dew formation inside the antenna device 100 when the temperature of the outside air is extremely low or when the humidity thereof is high, for example. The skirt 4 is made of a metal having a high thermal conductivity such as aluminum, and functions as a heat radiation surface to radiate to the outside air the heat which is generated by the array antenna 1, the power supply 6 and the control circuit 8 and transferred via the antenna adapter 2. In the present embodiment, the outside air refers to the air outside a space hermetically enclosed by the outer covering of the antenna device 100 composed of the radome 3, the skirt 4 and the outer surface 7 of the mobile object.

In the present embodiment, each of the radome 3 and the skirt 4 has, for example, an outer profile which is symmetrical with respect to the center line AA′ connecting the front portion and the rear portion of the mobile object. The transmitting array antenna 1a and the receiving array antenna 1b are preferably disposed on the surface of the antenna adapter 2 so as to be located on the center line AA′, whereby the arrangement is aerodynamically symmetrical.

The power supply 6 converts a power voltage supplied from the mobile object into an appropriate voltage and supplies the voltage to the array antenna 1 and the control circuit 8, respectively. The power supply 6 is composed of a plurality of elements and is fixed on the antenna adapter 2. When the power supply 6 operates to perform power conversion, heat is generated accordingly. The control circuit 8 is configured to control the array antenna 1. A plurality of electronic components are mounted on the control circuit 8, and heat is generated by the operation of the plurality of electronic components.

In the antenna device 100, the array antenna 1 is a primary heat source, and the power supply 6 and the control circuit 8 are secondary heat sources. Most of the heat generated by these heat sources is transferred through the antenna adapter 2 to the skirt 4 which serves as a heat radiation surface to radiate the heat to the outside air, but if the antenna adapter 2 is thin in thickness or the skirt 4 is small in heat radiation area, it is insufficient to radiate heat. Therefore, in the antenna device 100 according to the present embodiment, the blower 9 is provided in the space hermetically enclosed by the radome 3, the skirt 4 and the outer surface 7 of the mobile object. In the present embodiment, the blower 9 may be an air blower or a fan.

The blower 9 is disposed inside the space hermetically enclosed by the radome 3, the skirt 4 and the outer surface 7 of the mobile object, and is configured to forcibly circulate air inside the space (hereinafter referred to as “internal air 10”) so as to generate an airflow 14 that flows in a space surrounded by the radome 3 and the surface of the antenna adapter 2 on which the array antenna 1 is disposed. Further, the blower 9 is configured to circulate the airflow 14 via the through hole 11 between the space surrounded by the outer surface 7 of the mobile object and the surface of the antenna adapter 2 facing the outer surface 7 of the mobile object and the space surrounded by the radome 3 and the surface of the antenna adapter 2 on which the array antenna 1 is disposed.

In a thin antenna device 100 in which either the gap between the antenna adapter 2 and the outer surface 7 of the mobile object or the gap between the antenna adapter 2 and the radome 3 is about 10 mm, the pressure loss in the flow path is large, which makes it hardly possible to generate a natural convection by the density difference of the internal air 10. In the antenna device 100 according to the present embodiment, the blower 9 is provided, which makes it possible to apply a static pressure to the internal air 10 so as to generate the airflow 14.

FIG. 3 is a cross-sectional view illustrating a schematic structure of the antenna device according to the first embodiment of the present invention. FIG. 3 is the same as FIG. 1 except that FIG. 3 is added with an airflow 14. As illustrated in FIG. 3, the blower 9 is an axial blower, for example, and is disposed in the through hole 11e in such a manner that the rotation axis is perpendicular to the surface of the antenna adapter 2 on which the array antenna 1 is disposed. In the present embodiment, the term “perpendicular” does not have to be strictly perpendicular, and may be perpendicular to such an extent that the airflow 14 may flow through the through hole 11.

The blower 9 circulates the airflow 14, for example, from the space surrounded by the outer surface 7 of the mobile object and the surface of the antenna adapter 2 facing the outer surface 7 of the mobile object to the space surrounded by the radome 3 and the surface of the antenna adapter 2 on which the array antenna 1 is disposed. Hereinafter, the space surrounded by the radome 3 and the surface of the antenna adapter 2 on which the array antenna 1 is disposed is simply referred to as the array antenna 1 side, and the space surrounded by the outer surface 7 of the mobile object and the surface of the antenna adapter 2 facing the outer surface 7 of the mobile object is simply referred to as the outer surface 7 of the mobile object side.

The airflow 14 that is circulated from the outer surface 7 of the mobile object side into the array antenna 1 side through the through hole 11 e provided at a front position in the traveling direction of the mobile object flows along the inner wall of the radome 3. When the mobile object is, for example, an aircraft and is flying in the sky, since the radome 3 is cooled by the outside air, the airflow 14 flowing along the inner wall of the radome 3 is cooled. As a result, the temperature of the airflow 14 flowing around the array antenna 1 becomes lower than that in the case where the blower 9 is not installed, which makes it possible to convectively cool the array antenna 1 and the periphery of the array antenna 1 of the antenna adapter 2. Therefore, the temperature of the array antenna 1 is lower than that in the case where the blower 9 is not installed.

The airflow 14 receives heat around the array antenna 1, passes through the through hole 11f provided at a rear position in the traveling direction of the mobile object, and flows into the outer surface 7 of the mobile object. Since the airflow 14 that receives heat around the array antenna 1 is cooled by flowing along the inner wall of the radome 3, the temperature of the airflow 14 that flows into the outer surface 7 of the mobile object side through the through hole 11f is lower than that in the case where the blower 9 is not installed.

The airflow 14 that flows into the outer surface 7 of the mobile object side flows along the skirt 4 and the outer surface 7 of the mobile object. Similar to the radome 3, since the skirt 4 and the outer surface 7 of the mobile object are cooled by the outside air, the airflow 14 is cooled. As a result, the airflow 14 cools the power supply 6 and the control circuit 8 disposed on the surface of the antenna adapter 2 facing the outer surface 7 of the mobile object while flowing back to the blower 9.

Thus, by disposing the blower 9 in the space hermetically enclosed by the radome 3, the skirt 4 and the outer surface 7 of the mobile object to cause the airflow 14 to flow in the space surrounded by the radome 3 and the surface of the antenna adapter 2 on which the array antenna 1 is disposed, it is possible to cool the array antenna 1 which is the primary heat source, which makes it possible to improve the heat radiation efficiency of the antenna device 100.

Further, the blower 9 circulates the airflow 14 between the outer surface 7 of the mobile object side and the array antenna 1 side via the through hole 11. As a result, it is possible to increase the contact length between the airflow 14 and the radome 3, the skirt 4 and the outer surface 7 of the mobile object, the temperature of each is lowered by the outside air, and thereby it is possible to cool not only the array antenna 1 but also the power supply 6 and the control circuit 8 disposed on the surface of the antenna adapter 2 facing the outer surface 7 of the mobile object, which makes it possible to further improve the heat radiation efficiency of the entire antenna device 100.

In addition, since the blower 9 is an axial blower and has a small thickness in the flow direction, even if the antenna adapter 2 has only a thickness of, for example, about 20 mm, it is possible to install the blower 9 inside the through hole 11 without protruding out therefrom. Since the blower 9 is installed inside the through hole 11, the projection area of the antenna device 100 is not increased, which makes it possible to reduce the influence on the air resistance of the mobile object. Further, since the scanning area of the radio waves radiated from the array antenna 1 or the radio waves received by the array antenna 1 is not affected, it is possible to prevent the radio waves from being attenuated.

Further, since the blower 9 is disposed at a front position in the traveling direction of the mobile object and configured to cause the airflow 14 to flow from the outer surface 7 of the mobile object side into the array antenna 1 side, and flow back from the array antenna 1 side into the outer surface 7 of the mobile object side via the through hole 11f provided at a rear position of the antenna adapter 2 in the traveling direction of the mobile object, it is possible to increase the contact length between the airflow 14 and the inner wall of the radome 3, which makes it possible to further improve the heat radiation efficiency of the entire antenna device 100. In the present embodiment, as an example, it is described that the blower 9 is disposed at a front position of the mobile object in the traveling direction, however the same effect may be obtained by disposing the blower 9 at a rear position in the traveling direction of the mobile object and providing the through hole 11f at a front position in the traveling direction of the mobile object.

It is more preferable that the blower 9 is disposed in at least one of a tapered front end and a tapered rear end of the antenna adapter 2 in the traveling direction of the mobile object. In order to reduce the air resistance, it is preferable that the antenna device 100 has a small projection area, and thereby the component such as the array antenna 1 or the like is generally disposed in such a manner that the longitudinal direction thereof is identical to the traveling direction of the mobile object. Further, in order to reduce the air resistance of the antenna device 100, the antenna adapter 2 is formed into a substantially oval shape, and thus, the front end and the rear end of the antenna adapter 2 in the traveling direction of the mobile object are tapered. By arranging the blower 9 in at least one of the front end and the rear end of the antenna adapter 2 in the traveling direction of the mobile object, it is possible to effectively utilize the dead space where a component such as the array antenna 1 cannot be disposed.

It is further preferable that the through holes 11a and 11c, which are provided near the blower 9 and disposed with a receiving bracket to mate with the mounting bracket 5, are disposed with a flexible packing 24 (not shown) such as a nonwoven fabric to fill a penetration space between the array antenna 1 side and the outer surface 7 of the mobile object side. Even through the mounting bracket 5 is mated with the receiving bracket, a penetration space still remains in the through hole 11 between the array antenna 1 side and the outer surface 7 of the mobile object side. Therefore, a short circuit may occur between the blower 9 and the through holes 11a and 11c nearby the blower 9. By filling the penetration space with the packing 24, it is possible to prevent the short circuit from occurring nearby the blower 9, which makes it possible to improve the heat radiation efficiency of the array antenna 1. If the weight of the antenna device 100 is not particularly restricted, instead of filling the packing in the penetration space of the through hole 11 disposed near the blower 9, the same effect may be obtained by using a metal plate or the like to cover the penetration space.

In the present embodiment, the flow rate of an airflow to be generated by the blower 9 is determined by the pressure loss of the air passage and the static pressure of the blower 9. For example, when the gap between the antenna adapter 2 and the radome 3 is about 10 mm, it is possible to use the axial blower 9 having an area of about 80 mm² and a thickness of 20 mm or less to generate an airflow at a flow rate of about 0.4 m³/min. The cooling effect by the airflow 14 generated by the blower 9 changes depending on the temperature of air outside the radome 3, the airspeed of the mobile object and the like, but if the generated airflow circulates at a flow rate of about 0.4 m³/min, even taken into consideration the average air temperature of about 3000 meters in the sky, it is expected to lower the temperature of the array antenna 1 by several K in comparison with the case where the blower 9 is not provided. Conventionally, the temperature of the central portion of the array antenna 1 may not be sufficiently lowered only by heat conduction of the antenna adapter 2, but in the present embodiment, the airflow 14 is generated by the blower 9 to convectively carry the heat away from the surface of the array antenna 1, which makes the temperature of the array antenna 1 uniform.

Further, it is expected that the airflow 14 generated by the blower 9 may have an effect of preventing dew condensation in the antenna device 100. If the internal air 10 of the antenna device is not sufficiently dry, since the internal air 10 is in contact with the radome 3 which is cooled by the cold air in the upper sky, the temperature of the internal air 10 may be lowered below the dew point, which may cause dew condensation to occur inside the radome 3. However, since the airflow 14 is generated by the blower 9 to flow in the antenna device, the airflow 14 is warmed by the heat from the array antenna 1 or the like, and accordingly the inner wall of the radome 3 is warmed. Therefore, the temperature of the radome 3 is prevented from being lowered locally even in the upper sky, which makes it possible to prevent dew condensation from occurring.

Next, the details of the array antenna 1 which serves as a heat source will be described. The array antenna 1 is, for example, an RF array-type satellite communication antenna which communicates with a communication target such as an artificial satellite, and has a directivity to radiate radio waves in a direction toward the artificial satellite. Since the directivity of the array antenna 1 may be controlled by electrically controlling the phase of the antenna element 12, it is possible to make the array antenna 1 thinner than a mechanically driven antenna device in which an aperture or a reflecting plate of the antenna is mechanically driven to face the direction toward an artificial satellite.

The plurality of antenna elements 12 are disposed on a printed circuit board and configured to transmit or receive an RF (Radio Frequency) signal as the radio wave. The heat generation density of the array antenna 1 increases as the integration degree of the antenna element 12 becomes higher. The number of antenna elements 12 is determined by the scanning angle of the radio wave, the expected amount of loss of the radio wave, and the like. The interval between the antenna elements 12 varies depending on the wavelength of the radio wave to be used. The shorter the wavelength is, the narrower the interval between the antenna elements becomes. For example, for a Ka band antenna, the size of the array antenna 1 is about several dozen square centimeters.

The communication IC 13 includes electronic components such as a phase shifter that changes the phase of an RF signal transmitted or received by the array antenna 1 and an amplifier that amplifies the RF signal. These electronic components are installed on a printed circuit board, and are driven to perform a predetermined operation by a power voltage supplied from the power supply 6 and a control signal supplied from the control circuit 8. Each electronic component of the communication IC 13 generates a lot of heat during operation. The communication IC 13 is disposed such that a surface thereof opposite to the surface where the antenna elements 12 that radiate radio waves are disposed is used as a heat radiation surface and is bonded to the antenna adapter 2.

The amount of heat generated by the communication IC 13 varies depending on the semiconductor process of the electronic components. When, for example, the amount of the generated heat is of a kilowatt class, if the heat diffusion capability of the antenna adapter 2 in contact with the heat radiation surface of the communication IC 13 is low, the heat in the central portion of the planar communication IC 13 may not be sufficiently radiated. Each electronic component included in the communication IC 13 is a semiconductor element, and in order to allow the communication IC 13 to work at the desired performance, the junction temperature is required to be maintained at about 100° C. or lower.

Next, the size constraints of the antenna adapter 2 and an example joining structure will be described. The heat diffusion capability of the antenna adapter 2 may be improved by increasing the thickness and/or the cross-sectional area thereof, which leads to an increase in the projection area of the antenna device 100, in other words, an increase in the air resistance of the mobile object. Therefore, it is required to minimize the thickness of the antenna adapter 2.

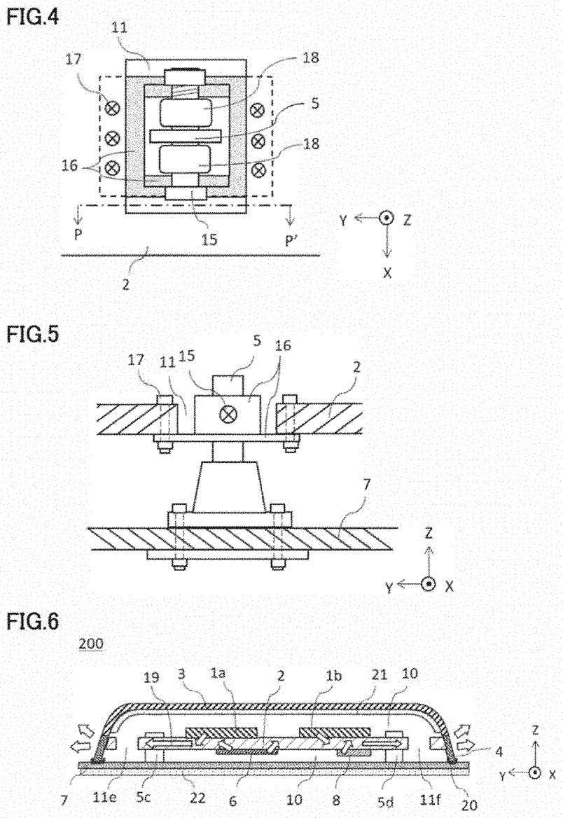

The joining structure between the antenna adapter 2 and the outer surface 7 of the mobile object is defined by the ARINC 791, which is one of the aircraft standards for civil aircrafts, for example. FIG. 4 is a plan view illustrating an enlarged part of the schematic structure of the antenna device according to the first embodiment of the present invention, and FIG. 5 is a cross-sectional view illustrating an enlarged part of the schematic structure of the antenna device according to the first embodiment of the present invention. FIG. 4 illustrates a joining structure between the mounting bracket 5 and the antenna adapter 2 when the inside of the radome 3 is viewed from above. FIG. 5 is a cross-sectional view taken along line PP′ of FIG. 4. As illustrated in FIGS. 4 and 5, the mounting bracket 5 provided on the outer surface 7 of the mobile object is joined to the antenna adapter 2 via a bolt 15 and a receiving bracket 16. Therefore, the antenna adapter 2 may be easily detached from the mobile object, facilitating the inspection or replacement at the time of a failure.

The receiving bracket 16 is attached to the through hole 11 of the antenna adapter 2 by a bolt 17. The receiving bracket 16 and the mounting bracket 5 are joined together by the bolt 15. In addition, a cushion member 18 such as a rubber bushing is interposed between the mounting bracket 5 and the receiving bracket 16 so as to absorb stress generated when the position of the mounting bracket 5 is changed due to the internal pressure of the mobile object. It is also required that the antenna adapter 2 and the outer surface 7 of the mobile object do not come into contact with each other when the mobile object is expanded due to the internal pressure, and in the ARINC 791, an interval of 8 mm or more is secured between the antenna adapter 2 and the outer surface 7 of the mobile object.

When the mobile object is flying, it is required to provide a lightning arrester for the antenna device 100. Although the surface of the radome 3 is provided with a structure for diverting a current at the time of a lightning strike, but if the gap between the inner wall of the radome 3 and the antenna element 12 is too small, the electrical discharge may cause dielectric breakdown. Therefore, it is preferable that the gap between the antenna adapter 2 and the outer surface 7 of the mobile object is about ten-odd millimeters.

In order to restrain the height of the projection surface of the antenna device 100 to, for example, about 5 centimeters while satisfying the size constraints, the thickness of the antenna adapter 2 is preferably 2 centimeters or less. Although the size of the antenna adapter 2 which serves as a base material of the array antenna 1 or the like varies depending on the size of a device to be mounted, and in a Ka band antenna defined by ARINC 791, the size is greater than 2 square meters.

Structurally, in the case where the skirt 4 disposed around the antenna adapter 2 is used as a heat radiation surface, when the communication IC 13 having a size of several dozen square centimeters generates heat of kilowatt class, the antenna adapter 2 which has a thickness of about 2 centimeters may not be sufficient to radiate the heat, which makes it difficult to lower the temperature of the central portion of the communication IC 13 to 100° C. or less. Even if the amount of heat generated by the communication IC 13 is less than a kilowatt, it is necessary to slightly reduce the thermal resistance from the antenna adapter 2 which has a thickness of about 2 centimeters to the skirt 4 which serves as a heat radiation surface.

Next, as a comparative example of the present invention, a heat radiation path 19 of an antenna device 200 having no blower 9 will be described. FIG. 6 is a schematic structure diagram illustrating a comparative example of the antenna device according to the first embodiment of the present invention. As a comparative example of the present invention, FIG. 6 illustrates a heat radiation path 19 for radiating heat from each heat source in the antenna device 200 having no blower 9.

When the mobile object is, for example, an aircraft and is flying in the sky, the temperature of the outside air may be lower than the freezing point depending on the flight altitude. If the airspeed is close to a subsonic speed, the radome 3, the skirt 4 and the outer surface 7 of the mobile object are sufficiently cooled by convection, and a low-temperature air layer 21 is formed near the inner wall of the radome 3. Therefore, in order to ensure heat radiation, it is important to efficiently transfer heat from each heat source to the radome 3, the skirt 4 and the outer surface 7 of the mobile object.

There are three types of heat transfer: heat conduction, heat radiation, and heat convection. A part of the heat generated by the heat source such as the array antenna 1 is transferred to the radome 3 and the outer surface 7 of the mobile object through heat radiation. However, the thermal conductivity of the air layer interposed between the radome 3 and the array antenna 1 is small. In addition, a component having a poor thermal conductivity such as a redistribution interposer is disposed on the surface of the array antenna 1 from which the radio wave is radiated, in other words, the surface facing the radome 3, and the radome 3 itself is also made of a material having a low thermal conductivity such as resin. Therefore, the amount of heat radiated from the surface of the array antenna 1 from which the radio wave is radiated through heat radiation to the outside air via the radome 3 is small. Further, although heat is radiated from the outer surface 7 of the mobile object facing the antenna adapter 2 through heat radiation, when the mobile object is, for example, an aircraft, a heat insulating material 22 is usually disposed on the outer surface 7 of the mobile object facing the mobile object, and the thickness of the outer surface 7 of the mobile object is as thin as several millimeters, whereby the heat radiation path is insufficient in radiating heat to the outside air. Therefore, most of the heat generated by the heat source such as the array antenna 1 is transferred to the antenna adapter 2.

The antenna adapter 2 is joined to the outer surface 7 of the mobile object via the mounting bracket 5. Since the mounting bracket 5 is provided with a cushion member 18 which is made of rubber and has a large thermal resistance, the heat radiation path is insufficient in transferring heat from the antenna adapter 2 to the outer surface 7 of the mobile object via the mounting bracket 5. Therefore, the heat generated by the heat source disposed on the antenna adapter 2 is diffused inside the antenna adapter 2 and transferred to the skirt 4.

The outer peripheral edge of the antenna adapter 2 is fixed to the skirt 4. The skirt 4 is joined to the radome 3. The radome 3 and the skirt 4 are exposed to the outside air. When the antenna device 100 is mounted on a mobile object such as an aircraft that moves at a high speed, since the temperature of the outside air in the upper sky is low and the airspeed of the mobile object is high, the heat resistance between to the outside air and the surface of the radome 3 is low. However, since the radome 3 is made of resin or the like which is easy for the radio wave to pass through and has a thickness of about ten-odd millimeters, the thermal diffusion in the surface direction is very low. Therefore, even when the radome 3 is cooled by the outside air and the low-temperature air layer 21 is formed near the inner wall of the radome 3, the contribution degree of the radome 3 as a heat radiation surface is low.

On the other hand, since the skirt 4 is made of a material having high thermal conductivity, the heat transferred from the antenna adapter 2 is easily diffused across the inner surface. As a result, the heat generated by the heat source such as the array antenna 1 is transferred from the antenna adapter 2, diffused in the skirt 4, and then released from the outer surface of the skirt 4 to the outside air.

In order to cool the array antenna 1 having a high heat generation density, it is required to reduce the thermal resistance of the antenna adapter 2 and increase the heat radiation area of the skirt 4. In order to reduce the thermal resistance of the antenna adapter 2, it is required to shorten the heat radiation path 19 from the heat source to the skirt 4 and increase the cross-sectional area of the heat radiation path 19. In order to increase the heat radiation area of the skirt 4, it is effective to increase the height from the outer surface 7 of the mobile object to the upper surface of the antenna adapter 2. However, these measurements lead to an increase in the size of the antenna apparatus 200, in other words, an increase in the air resistance of the mobile object.

The antenna adapter 2 is provided with a plurality of through holes 11 for joining with the mounting bracket 5. The through holes 11 are not only used to fix the antenna adapter 2, but also expected to reduce the weight of the antenna adapter 2. On the other hand, since the through holes 11 are arranged on the heat transfer path between the communication IC 13 serving as the heat generation source and the skirt 4 serving as the heat radiation surface, such arrangement may deteriorate the heat radiation efficiency of the antenna device 200.

As described above, if the antenna device 200 is not provided with a blower 9, the heat generated by the heat source such as the array antenna 1 is transferred to the antenna adapter 2 through heat conduction and/or radiated to the radome 3 or the outer surface 7 of the mobile object through heat radiation, but it is difficult to ensure sufficient heat radiation while reducing the overall thickness of the antenna device 200.

In the antenna device 100 according to the present embodiment, the blower 9 is installed in the radome 3 to apply a static pressure to the internal air 10 hermetically enclosed by the radome 3, the skirt 4 and the outer surface 7 of the mobile object so as to generate an airflow 14 and circulate the airflow 14 to flow along the radome 3, the inner wall of the skirt 4 and the outer surface 7 of the mobile object which are cooled by the outside air to a low temperature so as to radiate the heat generated by the heat source such as the array antenna 1 via the airflow 14. Thus, it is possible to improve the heat radiation efficiency even though the antenna device 100 is thin and thereby it is difficult to transfer heat to the antenna adapter 2 through heat conduction and/or radiate heat to the radome 3 or the outer surface 7 of the mobile object through heat radiation.

In the present embodiment, as an example, it is described that six through holes 11 are provided, but it is acceptable that at least two through holes 11 are provided, that is, one through hole is provided to allow the airflow 14 to flow from the outer surface 7 of the mobile object side to the array antenna 1 side and the other through hole is provided to allow the airflow 14 to flow from the array antenna 1 side to the outer surface 7 of the mobile object side. Further, as an example, it is described that the through holes 11a to 11d are provided to fix the mounting brackets 5 and the through hole 11f is provided to allow the airflow 14 to flow from the array antenna 1 side to the outer surface 7 of the mobile object side, and however, if the through holes 11a to 11d for fixing the mounting brackets 5 are provided at positions away from the blower 9 in the traveling direction of the mobile object with the array antenna 1 interposed therebetween and have a sufficiently large size to allow the airflow 14 to flow through, the through hole 11f for the airflow to flow through may not be provided. The number of the through holes 11 may be six or more, and may be provided to reduce the weight of the antenna adapter 2.

In the present embodiment, as an example, it is described that the blower 9 is provided to blow the airflow 14 from the outer surface 7 of the mobile object side to the array antenna 1 side, and however, the blower 9 may be provided to blow the airflow 14 from the array antenna 1 side to the outer surface 7 of the mobile object side as long as the airflow 14 may be circulated through the through hole 11.

Although in the present embodiment, as an example, it is described that the antenna adapter 2 is made of one piece of a plate material, the antenna adapter 2 may be obtained by joining a plurality of plate parts using bolts or the like.

### Second Embodiment

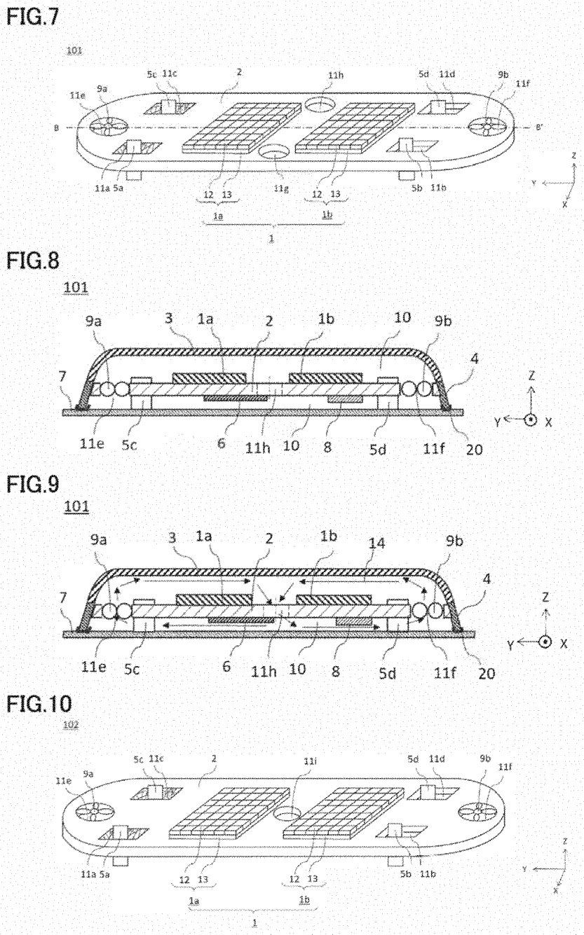

FIG. 7 is a perspective view illustrating a schematic structure of an antenna device according to a second embodiment of the present invention, and FIG. 8 is a cross-sectional view illustrating a schematic structure of the antenna device according to the second embodiment of the present invention. FIG. 8 is a cross-sectional view taken along line BB′ of FIG. 7, and in FIG. 7, in order to show components inside the antenna device 101, a part of the antenna device 101 is omitted. In the antenna device 100 according to the first embodiment, as an example, one blower 9 is provided, and however, in the antenna device 101 according to the present embodiment, in addition to a blower 9a provided at a front position in the traveling direction of the mobile object, a blower 9b is further provided at a rear position in the traveling direction of the mobile object. Further, through holes 11g and 11h are further provided in a middle portion of the antenna adapter 2 in the traveling direction of the mobile object. Hereinafter, the blowers 9a and 9b may be collectively referred to as the blower 9 where appropriate.

The blowers 9a and 9b are disposed at both ends of the antenna adapter 2 sandwiching the array antenna 1 in the traveling direction of the mobile object. For example, the blower 9a is disposed in the through hole 11e provided at a front position in the traveling direction of the mobile object, and the blower 9b is disposed in the through hole 11f provided at a rear position in the traveling direction of the mobile object, and both are aligned along line BB′ which is the center line of the antenna adapter 2 in the width direction.

In consideration of the air resistance, the antenna adapter 2 generally has a streamline shape, and the front end and the rear end in the traveling direction of the mobile object are narrowed with curvature. Since the array antenna 1 has the largest area among the components disposed on the antenna adapter 2, the overall width of the antenna adapter 2 is determined by the array antenna 1. Therefore, it is difficult to dispose the array antenna 1 at a location near the front end or the rear end of the antenna adapter 2 narrowed with curvature in the traveling direction of the mobile object. In addition, at a location near the front end or the rear end in the traveling direction of the mobile object, since the distance from the array antenna 1 to the skirt 4 is longer than the distance in the width direction, the thermal resistance of the path becomes relatively high, and thereby, it is difficult to use this path as the heat radiation path. Therefore, even if the through holes 11e and 11f are provided at the front end and the rear end of the antenna adapter 2 in the traveling direction of the mobile object to install the blowers 9a and 9b, there is little influence on the heat radiation efficiency.

The through holes 11g and 11h provided in a middle portion of the antenna adapter 2 in the traveling direction of the mobile object are spaced apart from the blower 9a and the blower 9b, respectively, and are located between the transmitting array antenna 1a and the receiving array antenna 1b in the traveling direction of the mobile object. In the present embodiment, the expression of “located between the transmitting array antenna 1a and the receiving array antenna 1b” means that the through holes may be provided in a region sandwiched between the transmitting array antenna 1a and the receiving array antenna 1b, or may be provided in a middle portion of the antenna adapter 2 but near the outer peripheral edge thereof in the traveling direction of the mobile object. In order to prevent a short circuit of the airflow from occurring, a flexible packing 24 such as non-woven fabric may be filled in the gap between the through holes 11a to 11d provided near the outer peripheral edge of the antenna adapter 2 for mating with the mounting brackets 5a to 5d and the mounting brackets 5a to 5d.

The antenna device 101 is filled with the internal air 10 that is isolated from the outside air. In a thin antenna device 101, since the gap between the antenna adapter 2 and the outer surface 7 of the mobile object and the gap between the antenna adapter 2 and the radome 3 are as small as about 10 mm, the pressure loss of the flow path is large. The larger the size of the blower 9 for forcing the convection of the internal air 10 is, the greater the static pressure may be obtained. However, taken into consideration that the blower 9 will be disposed on the antenna adapter 2 of at most about 2 centimeters long, it is difficult to obtain a sufficient air volume by using one blower. Therefore, in the antenna device 101 according to the present embodiment, the two blowers 9a and 9b are disposed at both ends of the antenna adapter 2 sandwiching the array antenna 1 in the traveling direction of the mobile object, which makes it possible to circulate a sufficient air volume in the antenna device 101.

FIG. 9 is a cross-sectional view illustrating a schematic structure of the antenna device according to the second embodiment of the present invention. FIG. 9 is obtained by adding an airflow 14 to the cross-sectional view of the antenna device 101 provided with two blowers 9a and 9b. The blowers 9a and 9b each generate an airflow 14 flowing from the outer surface 7 of the mobile object side to the array antenna 1 side. The airflow 14 passes through the radome 3 and the antenna adapter 2 toward a middle portion of the antenna device 101 in the traveling direction of the mobile object. When the mobile object is flying in the sky, the radome 3 is cooled by the outside air, whereby the airflow 14 flowing along the inner wall of the radome 3 is cooled.

The airflow 14 blown by the blower 9a and the airflow 14 blown by the blower 9b merge at the middle portion of the antenna device 101. The merged airflow 14 passes through the through holes 11g and 11h provided in the middle portion of the antenna adapter 2, and flows from the array antenna 1 side to the outer surface 7 of the mobile object side. After colliding with the outer surface 7 of the mobile object, the airflow 14 splits and flows toward the blower 9a and the blower 9b, and returns to the blower 9a and the blower 9b, respectively.

As described above, in the antenna device 101 according to the present embodiment, the blowers 9a and 9b are disposed in the space hermetically enclosed by the radome 3, the skirt 4 and the outer surface 7 of the mobile object to generate an airflow 14 that flows in the space surrounded by the radome 3 and the surface of the antenna adapter 2 on which the array antenna 1 is disposed, which improves the heat radiation efficiency of the antenna device 101.

Further, in the present embodiment, the blowers 9a and 9b are arranged at both ends of the antenna adapter 2 sandwiching the array antenna 1 in the traveling direction of the mobile object, which makes it possible to circulate a sufficient amount of the airflow 14 to the array antenna 1. Further, by providing the through holes 11g and 11h at the middle portion in the traveling direction of the mobile object between the transmitting array antenna 1a and the receiving array antenna 1b, it is possible to split the airflow 14 into two currents, which makes it possible to circulate a fresh current of the airflow 14 that is immediately cooled by the inner wall of the radome 3 to the surface of the transmitting array antenna 1a and the surface of the receiving array antenna 1b, respectively, whereby the array antenna 1 is preferentially cooled, which makes the communication performance of the antenna device 101 stable.

The through holes 11g and 11h through which the airflow 14 flows may not be strictly provided in the middle portion, and may be provided at any position between the blowers 9a and 9b in the traveling direction of the mobile object. If the through holes 11g and 11h are provided at a front position or a rear position in the traveling direction of the mobile object, the flow rates of the air flows generated by the blowers 9a and 9b may be different from each other. For example, in the case where the through holes 11g and 11h are provided at a front position closer to the blower 9a in the traveling direction of the mobile object, if the flow rate of the air flow generated by the blower 9a and the flow rate of the air flow generated by the blower 9b are the same, two airflows will merge exactly at the middle portion of the antenna adapter 2. Therefore, a complicated vortex will be formed between the merging point and the through holes 11g and 11h, whereby the pressure loss of the air passage becomes greater. Therefore, if the blowers 9a and 9b have a low static pressure, a sufficient air volume may not be obtained.

Therefore, a control unit configured to control the flow rate of the air flow generated by each of the blowers 9a and 9b is provided. The control unit, for example, increases the flow rate of the air flow generated by the blower 9a and decreases the flow rate of the air flow generated by the blower 9b relatively so that the merging point of the airflow 14 is positioned at the through holes 11g and 11h. Thus, it is possible to prevent unnecessary vortex from occurring, which makes it possible to reduce the pressure loss of the air passage. On the other hand, if the blowers 9a and 9b have a sufficiently large static pressure, the flow rate of the air flow generated by the blower 9a and the flow rate of the air flow generated by the blower 9b may be adjusted to locate the merging point of the airflow 14 in the vicinity of the array antenna 1 so as to form a vortex in the vicinity of the array antenna 1 intentionally, which makes it possible to improve the heat radiation efficiency of the array antenna 1. In addition, two blowers 9a and 9b having different maximum static pressures are used to adjust the flow rate of the air flow, but the blowers 9a and 9b having the same maximum static pressure may be used. In this case, the blowers 9a and 9b may be driven at different voltages.

FIG. 10 is a schematic structure diagram illustrating a modification of the antenna device according to the second embodiment of the present invention. In the antenna device 102 illustrated in FIG. 10, instead of the through holes 11g and 11h provided in the middle portion but near the outer peripheral edge of the antenna adapter 2 in the traveling direction of the mobile object, a through hole 11i is provided at a central position of the antenna adapter 2 sandwiched between the transmitting array antenna 1a and the receiving array antenna 1b.

Since the outer peripheral edge of the antenna adapter 2 constitutes the heat transfer path via heat conduction from the array antenna 1 serving as a heat source to the skirt 4 serving as a heat radiation surface, if the through hole 11 is interposed in the heat transfer path, the heat transfer path becomes apparently longer, which may increase the thermal resistance. The central position of the antenna adapter 2 is farthest from the skirt 4 which serves as a heat radiation surface, and the antenna adapter 2 plays little role as a heat radiation path for each heat source. In addition, the central position is sandwiched between the transmitting array antenna 1a and the receiving array antenna 1b, and the temperature thereof easily rises.

In the antenna device 102, by providing the through hole 11i at the central position of the antenna adapter 2, two currents of the airflow 14 merge at the central position of the antenna adapter 2, and the flow rate of the airflow 14 near the through hole 11i is maximum, which makes it possible to lower the temperature at the central position of the antenna adapter 2.

In the present embodiment, as an example, it is described that the blowers 9a and 9b are provided to blow the airflow 14 from the outer surface 7 of the mobile object side to the array antenna 1 side, and however, the blowers 9a and 9b may be provided to blow the airflow 14 from the array antenna 1 side to the outer surface 7 of the mobile object side as long as the airflow 14 may be circulated through the through hole 11.

### Third Embodiment

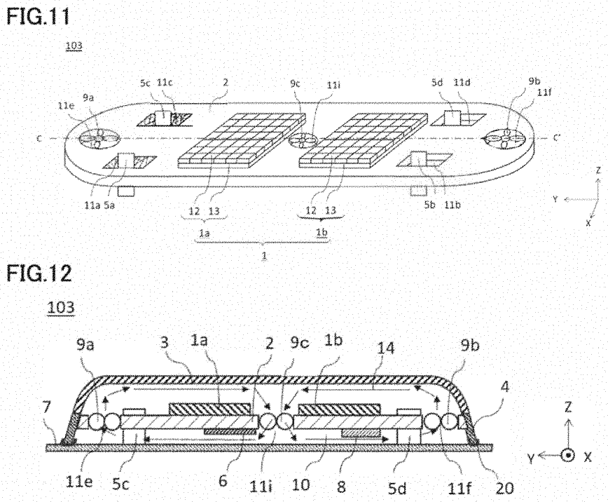

FIG. 11 is a perspective view illustrating a schematic structure of an antenna device according to a third embodiment of the present invention, and FIG. 12 is a cross-sectional view illustrating a schematic structure of the antenna device according to the third embodiment of the present invention. FIG. 12 is a cross-sectional view taken along line CC′ of FIG. 11, and in FIG. 11, in order to show components inside the antenna device 103, a part of the antenna device 103 is omitted. In the antenna device according to the first embodiment, one blower is provided, and in the antenna device according to the second embodiment, two blowers are provided, while in the antenna device 103 according to the present embodiment, three blowers 9a, 9b and 9c are provided.

The blowers 9a and 9b are disposed in the through holes 11e and 11f provided at both ends of the antenna adapter 2 sandwiching the array antenna 1 in the traveling direction of the mobile object. The blowers 9a and 9b each blow an airflow 14 from the outer surface 7 of the mobile object side to the array antenna 1 side.

In order to reduce the air resistance of the mobile object, it is important to reduce the projection area of the antenna adapter 2 in the traveling direction of the mobile object, and thus, rather than arranging the blower 9 or the like in a direction (X direction) orthogonal to the traveling direction of the mobile object, it is preferable to arrange the blower 9 or the like in the same direction as the traveling direction of the mobile object.

In the antenna device 103 according to the present embodiment, the blower 9c is further disposed in the through hole 11i provided at the central position of the antenna adapter 2 sandwiched between the transmitting array antenna 1a and the receiving array antenna 1b. The blower 9c blows an airflow 14 from the space surrounded by the radome 3 and the surface of the antenna adapter 2 on which the array antenna 1 is disposed to the space surrounded by the outer surface 7 of the mobile object and the surface of the antenna adapter 2 facing the outer surface 7 of the mobile object.

The airflows 14 blown by the blowers 9a and 9b, respectively, to flow from the outer surface 7 of the mobile object side to the array antenna 1 side, are cooled by the inner wall of the radome 3 while passing through the space between the radome 3 and the antenna adapter 2, and are directed toward the middle portion in the traveling direction of the mobile object. The airflow 14 merged at the middle portion is circulated by the blower 9c disposed in the through hole 11i provided at the central position of the antenna adapter 2 to flow from the array antenna 1 side to the outer surface 7 of the mobile object side. After colliding with the outer surface 7 of the mobile object, the airflow 14 splits and flows toward the blower 9a and the blower 9b, and returns to the blower 9a and the blower 9b, respectively.

As described above, in the antenna device 103 according to the present embodiment, the blowers 9a and 9b are disposed in the space hermetically enclosed by the radome 3, the skirt 4 and the outer surface 7 of the mobile object, and each blower is configured to generate an airflow 14 that flows in the space surrounded by the radome 3 and the surface of the antenna adapter 2 on which the array antenna 1 is disposed, which improves the heat radiation efficiency of the antenna device 103.

Further, in the present embodiment, the blower 9c is disposed at the central position of the antenna adapter 2 sandwiched between the transmitting array antenna 1a and the receiving array antenna 1b to blow an airflow 14 from the array antenna 1 side to the outer surface 7 of the mobile object side, whereby it is possible to increase the flow rate of the airflow 14 in the antenna device 103 having a large pressure loss of the flow path without increasing the air resistance of the antenna device 103 during movement, which makes it possible to efficiently cool the array antenna 1.

In the present embodiment, one blower 9 is disposed to blow an airflow from the array antenna 1 side to the outer surface 7 of the mobile object side, it is needless to say that the same effect may be obtained if two or more blowers 9 are disposed to blow the airflow from the array antenna 1 side to the outer surface 7 of the mobile object side as long as the two or more blowers 9 are disposed in a region sandwiched between the transmitting array antenna 1a and the receiving array antenna 1b.

Further, in the present embodiment, as an example, it is described that the blower 9a disposed at a front position and the blower 9b disposed at a rear position in the traveling direction of the mobile object each blow an airflow 14 from the outer surface 7 of the mobile object side to the array antenna 1 side, and the blower 9c disposed at the center position in the traveling direction of the mobile object blows an airflow 14 from the array antenna 1 side to the outer surface 7 of the mobile object side, and however, it is acceptable that the blowers 9a and 9b are disposed to blow an airflow 14 from the array antenna 1 side to the outer surface 7 of the mobile object side, and the blower 9c is disposed to blow an airflow from the outer surface 7 of the mobile object side to the array antenna 1 side as long as the airflow 14 may be circulated through the through hole 11.

In the first to third embodiments, as an example, the blower 9 is disposed in the through hole 11, but the blower 9 may be disposed outside the through hole 11 as long as the airflow 14 may be generated without increasing the projection area of the antenna device 100 and attenuating the radio wave of the array antenna 1.

In the first to third embodiments, as an example, the power supply 6 and the control circuit 8 are provided on the surface of the antenna adapter 2 opposite to the surface where the array antenna 1 is disposed, but the present invention is not limited thereto. The power supply 6 and the control circuit 8 may be provided on the same surface as the array antenna 1, or may be provided inside the mobile object.

Further, in the first to third embodiments, the blower 9 may be electrically joined to a monitor inside the mobile object so that the operating condition of the blower may be monitored from the inside of the mobile object. If the blower 9 is not operating normally, especially in the case where the outside air temperature is high, the temperature of the array antenna 1 may not be sufficiently cooled. If the operating condition of the blower 9 may be monitored from the inside of the mobile object, a control such as decreasing the data amount of satellite communication may be performed when the blower 9 is not operating normally.

The number of revolutions of the blower 9 may be specified from the inside of the mobile object. Needless to say that power is required to drive the blower 9. For example, if the temperature of the array antenna 1 may be maintained at a predetermined temperature or lower without forcing the internal air 10 to flow convectively in the case where the data amount of satellite communication is small or in the case where the temperature of the outside air is sufficiently low, the driving voltage of the blower 9 may be lowered so as to reduce the number of revolutions, which makes it possible to suppress energy consumption.

Further, the present invention may be achieved by appropriately combining a plurality of constituent elements disclosed in the first to third embodiments without departing from the spirit of the present invention.

### REFERENCE SIGNS LIST

1: array antenna; 2: antenna adapter; 3: radome; 4: skirt; 5, 5a-5d: mounting bracket; 6: power supply; 7: mobile object's outer surface; 8: control circuit; 9: blower; 10: internal air; 11, 11a-11i: through hole; 12: antenna element; 13: communication IC; 14: airflow; 15: bolt; 16: receiving bracket; 17: bolt; 18: cushion member; 19: radiation path; 20: elastic member; 21: low-temperature air layer; 22: heat insulating material

1. An antenna device comprising:
an array antenna that transmits a radio wave to a communication target or receives a radio wave from the communication target;
an antenna adapter that has a first surface on which the array antenna is disposed and a second surface facing an outer surface of a mobile object with a gap interposed therebetween, and is provided with a plurality of through holes penetrating the first surface on which the array antenna is disposed and the second surface facing the outer surface of the mobile object;
a radome that is provided to cover the first surface of the antenna adapter on which the array antenna is disposed with a gap interposed therebetween;
a skirt that is provided on an outer peripheral edge of the antenna adapter, one end of which is joined to the radome and the other end thereof is joined to the outer surface of the mobile object in close contact; and
a blower that is disposed inside a space hermetically enclosed by the radome, the skirt and the outer surface of the mobile object so as to generate an airflow flowing in a first space surrounded by the radome and the first surface of the antenna adapter on which the array antenna is disposed.

2. The antenna device according to claim 1, wherein
the blower circulates, via the through hole, the airflow between a second space surrounded by the outer surface of the mobile object and the second surface of the antenna adapter facing the outer surface of the mobile object and the first space surrounded by the radome and the first surface of the antenna adapter on which the array antenna is disposed.

3. The antenna device according to claim 1, wherein
the blower is an axial blower, and is disposed in at least one of the plurality of through holes in such a manner that a rotating shaft of the blower is perpendicular to the first surface of the antenna adapter on which the array antenna is disposed.

4. The antenna device according to claim 1, wherein
the blower blows, via the through hole, the airflow from the second space surrounded by the outer surface of the mobile object and the second surface of the antenna adapter facing the outer surface of the mobile object to the first space surrounded by the radome and the first surface of the antenna adapter on which the array antenna is disposed.

5. The antenna device according to claim 1, wherein
the blower is disposed at least one of a front portion or a rear portion in the traveling direction of the mobile object.

6. The antenna device according to claim 1 wherein
a part of the plurality of through holes is provided with a receiving bracket to mate with a mounting bracket provided on the surface of the mobile object for fixing the antenna adapter.

7. The antenna device according to claim 6, wherein
the through hole in which the receiving bracket is provided is disposed with a packing material to fill a penetration space between the first surface of the antenna adapter on which the array antenna is disposed and the second surface of the antenna adapter facing the outer surface of the mobile object.

8. The antenna device according to claim 1, wherein
the blowers are provided at both ends of the antenna adapter sandwiching the array antenna in the traveling direction of the mobile object.

9. The antenna device according to claim 8, wherein
the blowers provided at both ends of the antenna adapter sandwiching the array antenna in the traveling direction of the mobile object have different flow rates.

10. The antenna device according to claim 8, wherein
the array antenna includes a transmitting array antenna that transmits a radio wave to the communication target and a receiving array antenna that receives a radio wave from the communication target,
the transmitting array antenna and the receiving array antenna are disposed side by side along the traveling direction of the mobile object with an interval interposed therebetween, and
the antenna adapter is provided with the through hole in a middle portion located between the transmitting array antenna and the receiving array antenna.

11. The antenna device according to claim 1, wherein
a plurality of the blowers are provided, and
at least one of the blowers blows the airflow from the first space surrounded by the radome and the first surface of the antenna adapter on which the array antenna is disposed to the second space surrounded by the outer surface of the mobile object and the second surface of the antenna adapter facing the outer surface of the mobile object.

12. The antenna device according to claim 1, wherein
the communication target is an artificial satellite.
